(19) United States
(12) Patent Application Publication
(10) Pub. No.: US 2009/0244586 A1
(43) Pub. Date: Oct. 1, 2009

(54) IMAGE FORMING APPARATUS AND CHARGING METHOD

(75) Inventor: Masaaki Sei, Shizuoka (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/408,852

(22) Filed: Mar. 23, 2009

Related U.S. Application Data
(60) Provisional application No. 61/040,900, filed on Mar. 31, 2008.

(51) Int. Cl. G06F 3/12; G06Q 10/00

(52) U.S. Cl. 358/1.13; 358/1.15; 705/400

(57) ABSTRACT

An image forming apparatus include: a supply source that supplies image data formed in page units; a blank-paper detecting unit that discriminates whether the image data includes a blank page; an image forming unit that removes the blank page in the image data and forms an image on the basis of the image data other than the blank page; and a counter that counts a total number of pages of the image data supplied from the supply source and counts the number of valid pages obtained by excluding the blank page from the total number of pages. The image forming apparatus performs charging on the basis of a count value of the number of valid pages and displays the total number of pages and the number of the blank pages on a display unit using an output of the counter such that the total number of pages and the number of the blank pages can be compared.

### CROSS-REFERENCE TO RELATED APPLICATION

This application is based upon and claims the priority of U.S. Provisional Application 61/040,900 filed on Mar. 31, 2008, the entire contents of which are incorporated herein by reference.

### TECHNICAL FIELD

The present invention relates to image forming apparatuses such as an MFP (Multi-Function Peripheral), which is a digital complex machine, and a copying machine and a charging method involved in image formation.

### BACKGROUND

An image forming apparatus in the past, for example, an MFP, includes a scanner unit and a printer unit. The image forming apparatus can process image data scanned by the scanner unit and print the image data in the printer unit. When the MFP is set in a copy center or the like and used in plural departments, in some example, the MFP counts an actual state of use of the MFP for each of the departments to calculate a fee and charge the department for the use of the MFP.

When documents are scanned by the scanner unit of the MFP and scanned image data is processed and printed by the printer unit or converted into an electronic file, a charging system counts the number of scanned documents and calculates a fee.

However, even when a blank document is scanned, the document is counted as one document. Therefore, there is dissatisfaction that a proper fee is not calculated. For example, when documents of plural pages printed on both sides are scanned, if the number of pages is an odd number, the last page is blank. Therefore, a blank document is scanned.

On the other hand, some MFP has a blank paper removing function. The blank paper removing function is a function of performing blank paper detection and removing a blank page because it is unnecessary treat a blank document as valid image data when documents are scanned with the scanner unit and printed or converted into an electronic file.

The image forming apparatus in the past determines, after scanning a document, whether the document is a blank page, removes the blank page, and does not print the document if the document is the blank page by the blank paper removing function. However, since the charging system counts the number of scanned documents and calculates a fee, the charging system counts up even a blank page. Therefore, it is likely that a fee higher than a proper fee is collected.

JP-A-2001-169030 discloses an image processing apparatus that counts the number of printed sheets and charges a fee. In an example described in JP-A-2001-169030, when image data is blank image data, the number of counts is not added.

However, in the image forming apparatus in the past, when a user sets documents with a wrong method, there is a deficiency that a blank document is scanned and the user repeats the same mistake because the image forming apparatus cannot notify the user that the blank document is scanned.

### SUMMARY

According to an aspect of the present invention, there is provided an image forming apparatus including:

a supply source that supplies image data formed in page units;

a blank-paper detecting unit that discriminates whether the image data includes a blank page;

an image forming unit that removes the blank page in the image data using a detection result of the blank-paper detecting unit and forms an image on the basis of the image data other than the blank page;

a counter that counts a total number of pages of the image data supplied from the supply source and counts the number of valid pages obtained by excluding the blank page from the total number of pages;

a managing unit that performs charging on the basis of a count value of the number of valid pages; and

a display control unit that outputs information for displaying the total number of pages and the number of the blank pages on a display unit using an output of the counter such that the total number of pages and the number of the blank pages can be compared.

### DESCRIPTION OF THE DRAWINGS

FIG. 1 is a diagram of an embodiment of an image forming apparatus;

FIG. 2 is a block diagram of a circuit configuration of the image forming apparatus;

FIG. 3 is a flowchart for explaining operations of charging;

FIGS. 4A and 4B are diagrams for explaining display examples on a display unit; and

FIG. 5 is a flowchart for explaining an error indication displayed when all pages are blank.

### DETAILED DESCRIPTION

Throughout this description, the embodiments and examples shown should be considered exemplars, rather than limitations on the apparatus of the present invention.

An image forming apparatus according to an embodiment of the present invention is explained in detail below with reference to the accompanying drawings. In the drawings, the same components are denoted by the same reference numerals and signs.

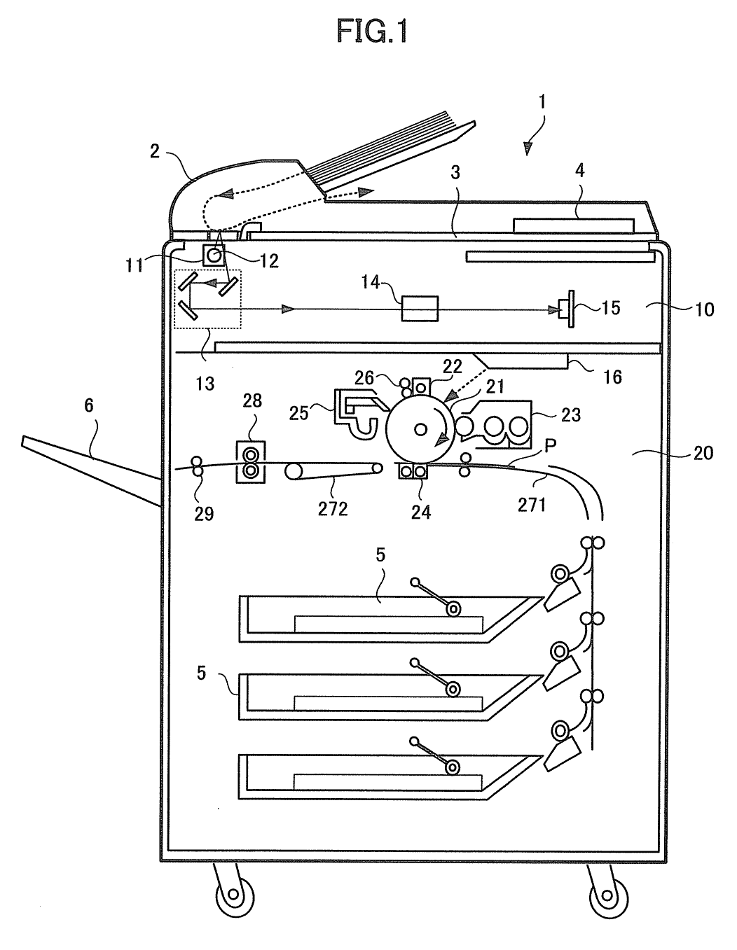

FIG. 1 is a diagram of the image forming apparatus according to this embodiment. In the following explanation, an MFP (Multi-Function Peripheral) as a complex machine is explained as an example of the image forming apparatus. An MFP 1 is set in a copy center or the like and shared by users in plural departments. In the example, the MFP 1 includes a charging system that counts an actual state of use of the MFP 1 in each of the departments and calculates a fee for each of the departments.

In FIG. 1, an auto document feeder (ADF) 2, a transparent document table 3, and an operation panel 4 are provided in an upper part of the image forming apparatus (the MFP) 1. The MFP 1 includes a scanner unit 10 and a printer unit 20. The scanner unit 10 scans an image of a document and the printer unit 20 prints the image on a sheet on the basis of scanned data.

The scanner unit 10 includes a carriage 11, an exposure lamp 12, a reflection mirror 13, a lens 14, a CCD (Charge Coupled Device) 15, and a laser unit 16. In order to scan a document fed by the ADF 2 or a document placed on the document table 3, the scanner unit 10 irradiates light from the exposure lamp 12 provided in the carriage 11 on the document from below the document table 3 and captures reflected light from the document into the CCD 15 via the reflection mirror 13 and the lens 14.

Image information captured into the CCD 15 is output as an analog signal. The analog signal is converted into a digital signal and subjected to image processing, whereby image data is generated. The image data is supplied to the laser unit 16. The laser unit 16 generates a laser beam according to the image data.

The printer unit 20 includes a photoconductive member 21 and includes a charging device 22, a developing device 23, a transfer device 24, a cleaner 25, and a charge removing lamp 26 around the photoconductive member 21 along a rotating direction. The laser beam from the laser unit 16 is irradiated on the photoconductive member 21. An electrostatic latent image corresponding to image information of the document is formed and held on the outer circumferential surface of the photoconductive member 21.

When image formation is started, the charging device 22 discharges in a discharging position and uniformly charges the outer circumferential surface of the rotating photoconductive member 21 in an axial direction. The laser beam is irradiated on the photoconductive member 21 from the laser unit 16 and an electrostatic latent image is formed and held on the outer circumferential surface of the photoconductive member 21.

A developer (e.g., a toner) is supplied to the outer circumferential surface of the photoconductive member 21 from the developing device 23 and the electrostatic latent image is converted into and developed as a toner image. The toner image formed on the outer circumferential surface of the photoconductive member 21 is electrostatically transferred onto a sheet P by the transfer device 24. The sheet P is conveyed from sheet feeding devices 5 (explained later) through a conveying path 271. The toner remaining on the photoconductive member 21 without being transferred is removed by the cleaner 25 located downstream in a rotating direction of the photoconductive member 21. Thereafter, residual charge on the outer circumferential surface of the photoconductive member 21 is removed by the charge removing lamp 26.

A configuration of the printer unit 20 is not limited to the example shown in the figure. Other systems such as a system employing an intermediate transfer belt can also be used. The MFP 1 can also process image data input from a PC (Personal Computer), output the image data to the printer unit 20, and print the image data.

On the other hand, in order to feed a sheet to the printer unit 20, plural sheet feeding devices 5 are provided below the printer unit 20. Sheets from the sheet feeding device 5 are conveyed to the transfer device 24 by the conveying path 271.

The sheet P having the toner image transferred thereon by the printer unit 20 is conveyed to a fixing device 28 through a conveyor belt 272. The fixing device 28 includes a heating roller and a pressing roller. The fixing device 28 fixes the toner image transferred on the sheet P is fixed on the sheet P by passing the sheet P between the heating roller and the pressing roller. The sheet P having the toner image fixed thereon and subjected to the image formation is discharged to a tray 6 by sheet discharging rollers 29.

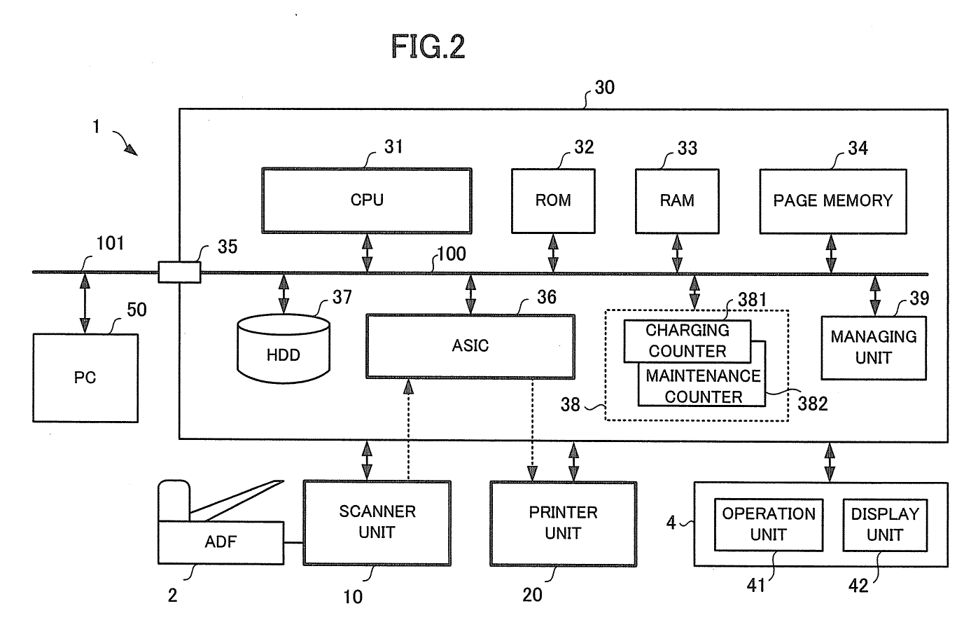

FIG. 2 is a block diagram of a circuit configuration of the MFP 1. In FIG. 2, the MFP 1 includes a main control unit 30. The operation panel 4, the scanner unit 10, and the printer unit 20 are connected to the main control unit 30.

The operation panel 4 includes an operation unit 41 including various keys such as a start key, a ten key, a scan key, a print key, and a setting and registration key. The operation panel 4 also includes a display unit 42 of liquid crystal or the like. The display unit 42 performs various kinds of display and has a touch panel function.

The scanner unit 10 lights a document with the exposure lamp 12, receives reflected light from the document with the CCD 15 to capture an image of the document, and converts the image into image data. The printer unit 20 processes the image data scanned by the scanner unit 10 or image data (document data, rendered image data, etc.) from a PC (explained later) and prints the image data on a sheet.

The ADF 2 is connected to the scanner unit 10. The scanner unit 10 operates together with the ADF 2 and scans in order documents in sheet units fed from the ADF 2. The scanner unit 10 also scans a document placed on the document table 3.

The main control unit 30 controls operations of the entire MFP 1 and includes a CPU 31. A ROM (Read Only Memory) 32, a RAM (Random Access Memory) 33, and a page memory 34 are connected to the CPU 31 via a PCI (Peripheral Component Interconnect) bus 100.

Various control program data necessary for the operations of the MFP 1 are stored in the ROM 32. The RAM 33 temporarily stores data during the operations of the MFP 1. A nonvolatile memory is used as the RAM 33. The page memory 34 has a storage area that can store image data for plural pages. The page memory 34 can store image data from the scanner unit 10 in page units.

The MFP 1 includes a network interface (I/F) 35 connected to the PCI bus 100. The network I/F 35 includes a LAN board and is connected to a PC (Personal Computer) 50 as an external apparatus via a network 101.

An ASIC (Application Specified IC) 36 as an image processing circuit, an HDD 37 as a storage device, a counter 38, and a managing unit 39 are connected to the PCI bus 100. The scanner unit 10 and the printer unit 20 are connected to the ASIC 36.

The ASIC 36 controls the page memory 34 to compress image data scanned by the scanner unit 10 and store the image data in the HDD 37. Alternatively, the ASIC 36 compresses image data supplied from the PC 50 and stores the image data in the HDD 37.

The ASIC 36 reads out the image data stored in the HDD 37 and processes the image data, applies image processing (gradation reproduction, etc.) to the image data, and outputs the image data to the printer unit 20. Further, the ASIC 36 processes the image data and converts the image data into an electronic file. The electronic file can be read by the PC 50.

Therefore, the scanner unit 10 and the PC 50 configure a supply source that supplies image data formed in page units to the ASIC 36 and the page memory 34.

The ASIC 36 and the printer unit 20 configure an image forming unit that forms an image on the basis of image data. The formation of an image means printing out the image data onto a sheet or converting the image data into an electronic file.

The storage of the image data in the HDD 37 and the readout of the image data from the HDD 37 are performed under the control by the CPU 31. The ASIC 36 also performs blank paper detection from the image data. Therefore, the ASIC 36 also functions as a blank-paper detecting unit. Details of the blank paper detection are explained later.

The counter 38 includes a charging counter 381 and a maintenance counter 382. When the user performs scanning of documents using the scanner unit 10, the charging counter 381 counts the number of scanned documents and generates charging data. However, when a blank document is scanned, the charging counter 381 excludes the blank document from charging targets and does not count the blank document.

When the user scans documents using the scanner unit 10, the maintenance counter 382 counts all the documents regardless of the number of blank documents.

The managing unit 39 configures a charging system together with the CPU 31. The managing unit 39 has a function for authenticating a user who uses the MFP 1. The managing unit 39 includes a management table and stores user information (user IDs, passwords, etc.), department information indicating departments to which users belong, and the like. When the user operates the operation panel 4 and inputs a user ID and a password, the managing unit 39 performs user authentication on the basis of data of the management table and permits the user to use the MFP 1. The managing unit 39 discriminates a department to which the user belongs and performs charging for each of departments.

Operations of the charging system of the MFP 1 are explained.

When the user scans documents using the MFP 1 and converts scanned data into an electronic file or print-outputs the scanned image, the charging system counts the number of valid pages of the scanned documents and sets a fee on the basis of a count value.

The conversion into an electronic file means scanning a document with the scanner unit 10, converting the document into electronic data such as a PDF (Portable Document Format), and stores the electronic data. A format of the electronic data may be, besides the PDF, formats such as XPS (XML Paper Specification) and TIFF (Tag Image File Format).

When documents are scanned by the scanner unit 10, image data is input to the page memory 34 through the ASIC 36. The ASIC 36 processes the image data to perform blank paper detection, discriminates whether scanned image data is a blank page, excludes the blank page, and converts the image data into an electronic file. When the scanned images are printed by the printer unit 20, the blank page is not printed.

When the documents are scanned by the scanner unit 10, the charging counter 381 counts up page by page. However, when a scanned document is a blank page, the charging counter 381 does not count up.

The managing unit 39 performs user authentication to determine departments of users who use the MFP 1 and grasps an actual state of use for each of departments to set a fee. The managing unit 39 determines, from a count value of the charging counter 381 the number of pages of documents printed or converted into an electronic format by users in each of the departments, charges each of the departments for the use of the MFP 1, and sets a fee. However, charging targets are only valid pages other than blank pages. When a scanned document is a blank page, the document is excluded from the charging targets.

The maintenance counter 382 counts the number of all pages of scanned documents regardless of whether a document is blank. Therefore, the user can learn an actual state of use of the MFP 1 on the basis of a count value of the maintenance counter 382.

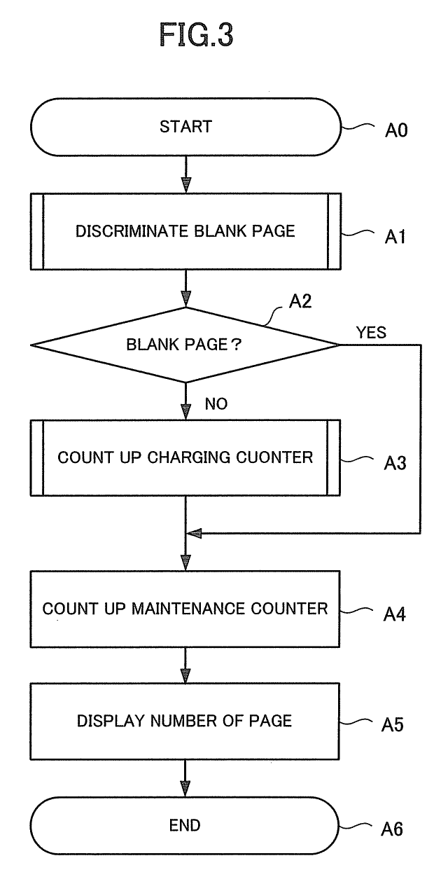

Operations of charging are explained with reference to a flowchart of FIG. 3.

In Act A0, the user sets documents in the ADF 2 of the MFP 1, enables the blank page removing function, and presses the start button of the operation unit 41. When the start button is pressed, the documents are sequentially fed from the ADF 2 to the scanner unit 10 and sequentially scanned by the scanner unit 10. Scanned image data is transferred to the page memory 34 through the ASIC 36. The ASIC 36 analyzes the scanned image data and, in Act A1, discriminates a blank page.

The image data scanned by the scanner unit 10 is discriminated by the ASIC 36 in page units whether the image data is a blank page. For example, the ASIC 36 determines an amount of color components included in image data for one page and, if the amount of color components is equal to or smaller than a threshold set in advance, determines that the image data is blank.

After discriminating whether the image data is a blank page, the ASIC 36 converts the image data into an electronic file excluding the blank page. When the scanned documents are printed by the printer unit 20, the blank page is not printed.

In Act A2, the ASIC 36 discriminates whether the scanned image data is a blank page and, if the scanned image data is a blank page, does not perform count-up of the charging counter 381. If the image data is a page other than blank paper, in Act A3, the ASIC 36 performs count-up of the charging counter 381.

In Act A4, the ASIC 36 performs count-up of the maintenance counter 382. The maintenance counter 382 counts the number of all scanned pages regardless of whether a scanned document is a blank page.

When scanning of a last document is finished, in Act A5, the ASIC 36 displays a total number of scanned pages and the number of blank pages (the number of removed pages) on the display unit 42 and, in Act A6, finishes the processing. Display control for the display unit 42 is performed under the control by the CPU 31. Therefore, the CPU 31 configures a display control unit.

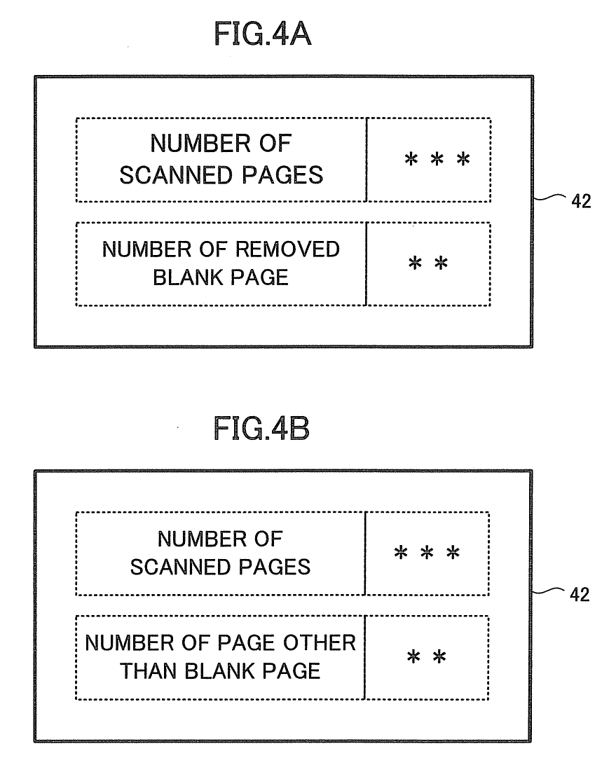

FIG. 4A is a diagram of a display example on the display unit 42. For example, a total number of scanned pages and the number of pages determined as blank pages and removed are displayed on the display unit 42. As shown in FIG. 4B, a total number of scanned pages and the number of valid pages other than blank paper may be displayed.

With the display shown in FIGS. 4A and 4B, the user can check the total number of scanned pages and the number of blank pages. The user can also check the number of valid pages excluding the number of blank pages. A display form is not limited to those shown in FIGS. 4A and 4B. Other display forms may be adopted as long as it is possible to compare the total number of scanned pages and the number of blank pages.

Several reasons are conceivable as a reason why a blank document is scanned. For example, when the user sets documents in the ADF 2, if the user sets a blank sheet by mistake or sets the documents upside down, a blank document is scanned.

When documents having images formed on both sides are scanned, if the documents end in an even number page, a blank document is not scanned. However, if the documents end in an odd number page, since the last page is blank, a blank document is scanned. Therefore, the user can learn that there is a blank page by looking at contents displayed on the display unit 42.

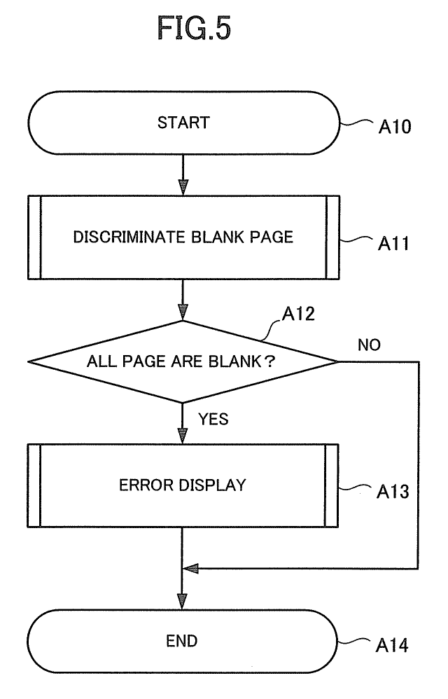

Operations for error display during document scanning are explained with reference to FIG. 5. When the user sets documents in the ADF 2, if the user sets the documents upside down by mistake, all pages are detected as blank pages. Therefore, even if scanned document data is converted into an electronic file, since all the pages are removed as blank paper, no data is left. Even if the scanned document data is printed, all the document data are removed as blank paper.

In Act A10 in FIG. 5, the user sets documents in the ADF 2 of the MFP 1, enables the blank page removing function, and presses the start button of the operation unit 41. When the start button is pressed, the documents are sequentially fed from the ADF 2 to the scanner unit 10 and the documents are sequentially scanned by the scanner unit 10. The ASIC 36 analyzes scanned image data and, in Act A11, discriminates a blank page. For example, if the user sets the documents upside down in the ADF 2, all the documents are determined as blank paper.

In Act A12, the ASIC 36 discriminates whether all pages are blank. If all the pages are blank, in Act A13, the ASIC 36 performs error display on the display unit 42. For example, the ASIC 36 displays a message such as “please turn over and resets documents”. If all the pages are not blank paper, the ASIC 36 does not perform error display, shifts to Act A14, and finishes the processing.

If all the pages are blank, since the ASIC 36 does not perform count-up of the charging counter 381, the pages are not set as charging targets. It is possible to notify the user that there is a mistake in a method of setting documents.

On the other hand, the maintenance counter 382 counts the number of all pages of the scanned documents and outputs maintenance information on the basis of a count value. Since the maintenance counter 382 counts the number of all pages of the scanned documents, the user can grasp an actual state of use of the MFP 1. It is possible to notify the user of timing of maintenance and inspection by outputting, as the maintenance information, for example, the total number of pages counted by the maintenance counter 382 to the display unit 42.

In the example explained above, the user sets documents in the ADF 2, scans the documents with the scanner unit 10, and converts scanned document data into an electronic file or print-outputs the document data. However, when image data sent from the PC 50 is processed and converted into an electronic file or printed, the same charging is performed.

The ASIC 36 stores image data supplied from the PC 50 in the HDD 37, reads out and processes the image data stored in the HDD 37, and outputs the image data to the printer unit 20 or converts the image data into an electronic file. The ASIC 36 discriminates the image data from the PC 50 into blank pages and pages other than blank paper and removers the blank pages and converts only valid pages other than the blank paper into an electronic file or print-outputs the valid pages.

When there is a blank page, the charging counter 381 does not perform count-up. Charging information is displayed in the PC 50 used by the user. The display of the charging information may be the same as the contents shown in FIGS. 4A and 4B.

When image data of documents scanned by the scanner unit 10 is converted into an electronic file and sent to the PC 50, the image data excluding a blank page may be converted into an electronic file and subjected to charging for the image data other than the blank page.

In the embodiment explained above, when documents are converted into an electronic file in a copy center or the like, there is not blank page on the electronic file. When charging is performed, it is possible that a blank page is treated as being excluded from charging targets.

Therefore, charging is not applied to the blank page, i.e., an invalid page and is performed according to valid pages, it is possible to set a proper fee. Not only the number of scanned documents but also the number of valid pages or invalid pages is displayed. Therefore, when the user sets documents, it is possible to warn the user that the user sets the documents in a wrong way.

The maintenance counter 382 counts the number of all scanned documents. Therefore, the user can accurately learn an actual state of use of the MFP 1. This is effective in determining timing for inspection and repair.

In the embodiment explained above, the MFP 1 is set in the copy center or the like and shared by the plural departments. However, the MFP 1 may be leased and used in one department or one company. When the MFP 1 is leased and used in one department, it is unnecessary to manage the MFP 1 for each of departments. It goes without saying that charging can be properly performed according to the number of valid pages.

Although exemplary embodiments are shown and described, it will be apparent to those having ordinary skill in the art that a number of changes, modifications, or alterations as described herein may be made, none of which depart from the spirit. All such changes, modifications, and alterations should therefore be seen as within the scope.

What is claimed is:

1. An image forming apparatus comprising:
a supply source that supplies image data formed in page units;
a blank-paper detecting unit that discriminates whether the image data includes a blank page;
an image forming unit that removes the blank page in the image data using a detection result of the blank-paper detecting unit and forms an image on the basis of the image data other than the blank page;
a counter that counts a total number of pages of the image data supplied from the supply source and counts the number of valid pages obtained by excluding the blank page from the total number of pages;
a managing unit that performs charging on the basis of a count value of the number of valid pages; and
a display control unit that outputs information for displaying the total number of pages and the number of the blank pages on a display unit using an output of the counter such that the total number of pages and the number of the blank pages can be compared.

2. The apparatus of claim 1, wherein the image forming unit includes an image processing circuit that converts the image data supplied from the supply source into an electronic file.

3. The apparatus of claim 1, wherein the image forming unit includes a printer unit that print-outputs the image data supplied from the supply source.

4. The apparatus of claim 1, wherein the supply source includes a scanner unit that scans documents or an external apparatus connected to the image forming apparatus.

5. The apparatus of claim 1, wherein the display unit displays information concerning the total number of pages counted by the counter and the number of removed blank pages.

6. The apparatus of claim 1, wherein the display unit displays information concerning the total number of pages counted by the counter and the number of valid pages.

7. The apparatus of claim 1, wherein, when the blank-paper detecting unit determines that all pages are blank, the apparatus performs error display on the display unit.

8. The apparatus of claim 1, wherein the counter outputs maintenance information using a count value of the total number of pages.

9. An image forming apparatus comprising:
a scanner unit that scans documents and generates image data;
a blank-paper detecting unit that discriminates whether the image data includes a blank page;
an image forming unit that removes the blank page in the image data using a detection result of the blank-paper detecting unit and converts the image data other than the blank page into an electronic file or print-outputs the image data other than the blank page;
a counter that counts a total number of pages of documents scanned by the scanner unit and counts the number of valid pages obtained by excluding the blank page from the total number of pages;
a managing unit that performs charging on the basis of a count value of the number of valid pages; and
a display unit that displays the total number of pages and the number of the blank pages using an output of the counter such that the total number of pages and the number of the blank pages can be compared.

10. The apparatus of claim 9, wherein the display unit displays information concerning the total number of pages counted by the counter and displays information concerning at least one of the number of removed blank pages and the number of valid pages.

11. The apparatus of claim 9, wherein, when the blank-paper detecting unit determines that all pages are blank, the apparatus performs error display on the display unit.

12. The apparatus of claim 9, wherein the counter outputs maintenance information using a count value of the total number of pages.

13. A charging method for an image forming apparatus comprising:
inputting image data formed in page units from a supply source;
discriminating in a blank-paper detecting unit whether the image data includes a blank page;
removing the blank page in the image data using a result of the detection and forming an image in an image forming unit on the basis of the image data other than the blank page;
counting a total number of pages of the image data input from the supply source and counts the number of valid pages obtained by excluding the blank page from the total number of pages;
performing charging on the basis of a count value of the number of valid pages; and
displaying the total number of pages and the number of the blank pages on a display unit using an output of the counter such that the total number of pages and the number of the blank pages can be compared.

14. The method of claim 13, wherein the image forming unit processes the image data supplied from the supply source and converts the image data into an electronic file.

15. The method of claim 13, wherein the image forming unit processes the image data from the supply source and print-outputs the image data.

16. The method of claim 13, wherein the supply source includes a scanner unit that scans documents or an external apparatus connected to the image forming apparatus.

17. The method of claim 13, further comprising displaying, on the display unit, information concerning the total number of pages counted by the counter and the number of removed blank pages.

18. The method of claim 13, further comprising displaying, on the display unit, information concerning the total number of pages counted by the counter and the number of valid pages.

19. The method of claim 13, further comprising, when the blank-paper detecting unit determines that all pages are blank, performing error display on the display unit.

20. The method of claim 13, further comprising outputting maintenance information using a count value of the total number of pages.
